(19) United States
(12) Patent Application Publication
(10) Pub. No.: US 2026/0193095 A1
(43) Pub. Date: Jul. 9, 2026

(54) PRECURSOR OF CATHODE ACTIVE MATERIAL

(71) Applicant: TOYOTA JIDOSHA KABUSHIKI KAISHA, Toyota-shi (JP)

(72) Inventor: Momoko PROCTER, Seto-shi (JP)

(73) Assignee: TOYOTA JIDOSHA KABUSHIKI KAISHA, Toyota-shi (JP)

(21) Appl. No.: 19/387,801

(22) Filed: Nov. 13, 2025

(30) Foreign Application Priority Data
Jan. 9, 2025 (JP) 2025-003192

(51) Int. Cl. C01G 53/04

(52) U.S. Cl. CPC C01G 53/04; C01P 2004/45; C01P 2006/12; C01P 2006/40

(57) ABSTRACT

A precursor of a cathode active material includes secondary particles each including a plurality of primary particles aggregated together. The primary particles include a nickel composite hydroxide. The precursor has an average pore size of more than 3.60 μm and a total pore specific surface area of less than 0.26 m²/g, as measured by mercury intrusion porosimetry.

### CROSS-REFERENCE TO RELATED APPLICATION

This application claims priority to Japanese Patent Application No. 2025-003192 filed on Jan. 9, 2025. The disclosure of the above-identified application, including the specification, drawings, and claims, is incorporated by reference herein in its entirety.

### BACKGROUND

### 1. Technical Field

The present disclosure relates to precursors of cathode active materials.

### 2. Description of Related Art

Various techniques have been proposed regarding cathode active materials such as those disclosed in Japanese Unexamined Patent Application Publication Nos. 2024-83946 (JP 2024-83946 A) and 2005-194106 (JP 2005-194106 A).

### SUMMARY

Conventionally, various cathode active materials have been proposed in order to obtain a cathode having excellent battery characteristics such as high cycle characteristics and high output characteristics.

For example, JP 2024-83946 A describes a precursor of a cathode active material for a lithium-ion secondary battery. This precursor is composed of a lithium metal composite hydroxide including secondary particles formed by aggregation of primary particles. JP 2024-83946 A describes that, by forming a shell portion with high particle strength around a core portion having a particle structure such as a high-porosity structure, a hollow structure, or a porous structure, a cathode active material for a lithium-ion secondary battery can be obtained that maintains good battery characteristics while also exhibiting high particle strength.

However, the cathode active material obtained by calcining the precursor described in JP 2024-83946 A is susceptible to damage such as cracking. When such damage occurs, the specific surface area of the cathode active material increases, resulting in poor durability of the cathode active material and causing a reduction in the capacity of the secondary battery. Therefore, there is a demand for a cathode active material having excellent durability.

The present disclosure has been made in view of the above circumstances, and a main object thereof is to provide a precursor of a cathode active material that can produce a cathode active material having excellent durability.

The present disclosure includes the following aspects.
(1) A precursor of a cathode active material, the precursor including secondary particles each including a plurality of primary particles aggregated together, wherein:
the primary particles include a nickel composite hydroxide; and
the precursor has an average pore size of more than 3.60 μm and a total pore specific surface area of less than 0.26 m²/g, as measured by mercury intrusion porosimetry.
(2) The precursor according to (1), wherein the average pore size is 8.90 μm or less, and the total pore specific surface area is 0.06 m²/g or more.
(3) The precursor according to (1) or (2), wherein the average pore size is 4.20 μm or more, and the total pore specific surface area is 0.25 m²/g or less.
(4) The precursor according to any one of (1) to (3), wherein the nickel composite hydroxide is a nickel-cobalt-manganese composite hydroxide.

The present disclosure can provide a precursor of a cathode active material that can produce a cathode active material having excellent durability.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram illustrating an example of the structure of a precursor according to the present disclosure.

### DETAILED DESCRIPTION OF EMBODIMENTS

An embodiment according to the present disclosure will now be described. It should be noted that matters not specifically mentioned in the present specification but necessary to carry out the present disclosure (for example, general configurations and production processes of a cathode active material and its precursor that are not characteristic of the present disclosure) may be understood as design matters for those skilled in the art based on conventional techniques in the art. The present disclosure may be carried out based on the content disclosed in the present specification and the common general technical knowledge in the art.

The dimensional relationships (such as length, width, and thickness) shown in the drawings do not reflect the actual dimensional relationships.

The present disclosure provides a precursor of a cathode active material. The precursor includes secondary particles each including a plurality of primary particles aggregated together. The primary particles include a nickel composite hydroxide. The precursor has an average pore size of more than 3.60 μm and a total pore specific surface area of less than 0.26 m²/g, as measured by mercury intrusion porosimetry.

The present inventors have found that a cathode active material with high strength can be obtained by using a precursor having a large average pore size and a small total pore specific surface area as described above. This is considered to be because a precursor having such pore characteristics allows the reaction to sufficiently proceed inside the secondary particles of the precursor during calcination. By improving the strength of the cathode active material, it is possible to suppress an increase in degraded surfaces of the cathode active material both in the initial stage and during charge and discharge cycles. Thus, according to the present disclosure, a cathode active material can be obtained that has high durability and exhibits excellent cycle characteristics.

In the precursor of the present disclosure, the average pore size as measured by mercury intrusion porosimetry can be any value greater than 3.60 μm. The average pore size may be 4.20 μm or more, or may be 9.00 μm or less, or 8.90 μm or less.

In the precursor of the present disclosure, the total pore specific surface area as measured by mercury intrusion porosimetry can be any value less than 0.26 m²/g. The total pore specific surface area may be 0.25 m²/g or less, or may be 0.05 m²/g or more, or 0.06 m²/g or more.

Any known method may be used to measure the average pore size and the total pore specific surface area by mercury intrusion porosimetry, and a mercury porosimeter may be used.

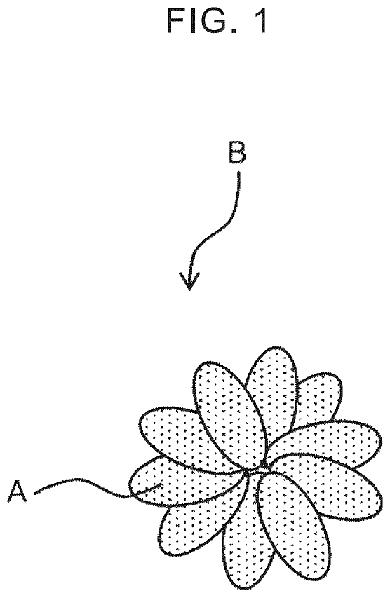

FIG. 1 is a conceptual diagram illustrating an example of the structure of the precursor according to the present disclosure. The precursor of the present disclosure includes secondary particles B each including a plurality of primary particles A aggregated together as shown in FIG. 1. In addition to the secondary particles, the precursor of the present disclosure may also include primary particles existing individually without aggregation.

In the present disclosure, the primary particles include a nickel composite hydroxide. The nickel composite hydroxide is a hydroxide containing nickel (Ni) and another metal species other than nickel. The other metal species other than nickel may be of one kind or two or more kinds. Examples of the other metal species other than nickel include manganese (Mn), cobalt (Co), and aluminum (Al). Specific examples of nickel composite hydroxides include a nickel-cobalt composite hydroxide containing nickel and cobalt, a nickel-cobalt-manganese composite hydroxide containing nickel, cobalt, and manganese, and a nickel-cobalt-aluminum composite hydroxide containing nickel, cobalt, and aluminum. The nickel composite hydroxide may be a nickel-cobalt-manganese composite hydroxide.

In these nickel composite hydroxides, the ratios (molar ratios) of nickel and the other metal species to the total amount of nickel and the other metal species are not particularly limited. In the case of a nickel-cobalt composite hydroxide, the molar ratios may be as follows. Ni/NiCo may be 0.5 or more and 1.0 or less, and Co/NiCo may be 0 or more and 0.5 or less. In the case of a nickel-cobalt-manganese composite hydroxide, the molar ratios may be as follows. Ni/NiCoMn may be 0.5 or more and 1.0 or less, Co/NiCoMn may be 0 or more and 0.3 or less, and Mn/NiCoMn may be 0 or more and 0.3 or less. In the case of a nickel-cobalt-aluminum composite hydroxide, the molar ratios may be as follows. Ni/NiCoAl may be 0.5 or more and 1.0 or less, Co/NiCoAl may be 0 or more and 0.3 or less, and Al/NiCoAl may be 0 or more and 0.3 or less.

In the present disclosure, the nickel composite hydroxide may further contain another metal species other than nickel, cobalt, aluminum, and manganese. The other metal species may include at least one selected from the group consisting of, for example, Zr, Mo, Mg, Ca, Na, Fe, Cr, Zn, Si, Sn, and Ag.

The size of the primary particles is not particularly limited. For example, when the particles have a flat shape such as a plate or needle shape, the average value of the length in the short-side direction (thickness) may be from 10 nm to 200 nm. The size of the primary particles can be determined by, for example, measuring the thicknesses of cross sections of a plurality of primary particles in transmission electron microscope (TEM) images or scanning electron microscope (SEM) images and calculating the average value thereof.

The size of the secondary particle formed by aggregation of a plurality of such primary particles is not particularly limited. For example, the average particle size of the secondary particles may be from 4 μm to 15 μm, or may be from 4 μm to 10 μm. As in the case of the primary particles, the average particle size of the secondary particles can be determined by measuring the particle sizes of a plurality of secondary particles in TEM observation or SEM observation and calculating the average value thereof.

The method for producing the precursor of the cathode active material of the present disclosure is not particularly limited, and examples include the following method. First, a water-soluble nickel source (nickel compound) serving as a starting material of the nickel composite hydroxide, and another water-soluble metal source (such as a cobalt compound, a manganese compound, or an aluminum compound) are dissolved in deionized water to prepare an aqueous metal source solution. At this time, in the aqueous metal source solution, the ratios (mol %) of nickel and the other metal species to the total amount of nickel and the other metal species are typically adjusted to be equal to the ratios (mol %) of nickel and the other metal species in the nickel composite hydroxide to be formed. The water-soluble metal compounds are not particularly limited, and examples include sulfates. Next, a certain amount of aqueous NH₃ solution (ammonium ion donor) is placed in a reaction vessel, and while stirring with a stirrer etc., the atmosphere is purged with nitrogen to create a non-oxidizing atmosphere. The flow rate of nitrogen gas for the nitrogen purging is not particularly limited, and may be, for example, from 2 L/min to 6 L/min. Subsequently, an aqueous sodium hydroxide solution is added to the reaction vessel, and while maintaining the pH in the alkaline range (e.g., pH 11.3 to pH 12.0), the aqueous metal source solution and the aqueous NH₃ solution are added dropwise into the reaction vessel over five hours to 15 hours. The reaction temperature is not particularly limited, and may be, for example, from 50° C. to 65° C.

After completion of the reaction, a drying treatment is performed. For example, the drying treatment may be carried out at 110° C. for 10 hours under an inert gas atmosphere.

The precursor of the cathode active material of the present disclosure can be used as, for example, a cathode active material for a battery such as a lithium-ion battery by being converted into a lithium-nickel composite oxide.

The lithium-nickel composite oxide can be produced from the precursor of the present disclosure by, for example, the following method. The nickel composite hydroxide that is the precursor of the present disclosure is mixed with a lithium compound serving as a lithium source, and the obtained mixture is calcined.

The lithium compound may be, for example, at least one selected from lithium carbonate, lithium nitrate, lithium acetate, lithium hydroxide, lithium oxide, and lithium chloride.

The ratio of the lithium compound to the precursor in the mixture is typically adjusted such that the ratios (mol %) of lithium and the other metal species to the total amount of lithium and the other metal species in the target cathode active material becomes equal to the ratios (mol %) of lithium and the other metal species in the mixture. The mixing method is not particularly limited, and any known method may be used.

The obtained mixture is calcined, for example, at 700° C. to 950° C. for eight hours to 15 hours under an oxygen atmosphere. A lithium-nickel composite oxide can thus be obtained. Known calcination furnaces such as a muffle furnace can be used for the calcination.

The cathode active material obtained by calcining the precursor of the present disclosure is generally considered to be composed of single-crystal particles.
As used herein, the “single-crystal particle” refers to a single particle that does not form a secondary particle and that is substantially composed of a single crystal. Whether the particles are single-crystal particles can be confirmed by the absence of grain boundaries in an SEM image.

The precursor of the cathode active material provided by the present disclosure can be used as, for example, a precursor of a cathode active material constituting the cathode of a battery (such as a lithium-ion battery). That is, the present disclosure can provide a battery in which a cathode, an electrolyte layer, and an anode are stacked in this order and the cathode contains a cathode active material obtained from the precursor of the present disclosure.

The battery will now be described.

The cathode includes a cathode layer, and may further include a cathode current collector.

The cathode layer is a layer containing at least a cathode active material. The cathode active material may solely contain the cathode active material obtained from the precursor of the present disclosure, or may further contain another active material. The content of the cathode active material in the cathode layer is not particularly limited, and may be, for example, from mass % to 80 mass %.

The cathode layer may further contain at least one of the following: an electrolyte, an electrically conductive material, and a binder.

Examples of electrolytes include solid electrolytes. The solid electrolyte may be an inorganic solid electrolyte such as a sulfide solid electrolyte, a halide solid electrolyte, an oxide solid electrolyte, or a complex hydride solid electrolyte, or may be an organic solid electrolyte such as a gel electrolyte. The proportion of the solid electrolyte in the cathode layer may be, for example, from 10 mass % to 60 mass %.

Examples of electrically conductive materials include carbon materials, metal particles, and electrically conductive polymers. Examples of carbon materials include particulate carbon materials such as acetylene black (AB) and Ketjen black (KB), and fibrous carbon materials such as vapor-grown carbon fibers (VGCFs), carbon nanotubes (CNTs), and carbon nanofibers (CNFs). The proportion of the electrically conductive material in the cathode layer may be, for example, from 0.1 mass % to 5 mass %.

Examples of binders include styrene-butadiene rubber (SBR), acrylonitrile-butadiene rubber (NBR), butadiene rubber (BR), polyvinylidene fluoride (PVDF), polytetrafluoroethylene (PTFE), styrene-isoprene-styrene block copolymers (SISs), and ethylene-propylene-diene copolymers (EPDMs). The proportion of the binder in the cathode layer may be, for example, from 0.5 mass % to 5 mass %.
Examples of materials for the cathode current collector include SUS, Cr, Au, Pt, Zn, aluminum, copper, nickel, iron, titanium, and carbon. The thickness of the cathode current collector is, for example, 0.1 μm or more and 100 μm or less. The cathode current collector may be in the form of a foil or a plate. The shape of the cathode current collector as viewed in plan is not particularly limited, and examples include circular, elliptical, rectangular, and any polygonal shapes. The cathode current collector may have a structure in which a buffer layer, an elastic layer, or a positive temperature coefficient (PTC) thermistor layer is provided on its surface.

The anode includes an anode layer, and may further include an anode current collector.

The anode layer is a layer containing at least an anode active material. The anode layer may further contain at least one of the following: an electrolyte, an electrically conductive material, and a binder. Examples of anode active materials for lithium-ion batteries include carbon materials such as natural graphite, lithium metal, and lithium alloys.
The electrolyte, electrically conductive material, and binder used in the anode layer may be the same as those described above for the cathode layer.
Examples of materials for the anode current collector include SUS, aluminum, copper, nickel, iron, titanium, and carbon. The thickness of the anode current collector is, for example, 0.1 μm or more and 100 μm or less. The anode current collector may be in the form of a foil or a plate. The shape of the anode current collector as viewed in plan is not particularly limited, and examples include circular, elliptical, rectangular, and any polygonal shapes. The anode current collector may have a structure in which a buffer layer, an elastic layer, or a PTC thermistor layer is provided on its surface.

The electrolyte layer is a layer formed between the cathode layer and the anode layer and contains at least an electrolyte. Examples of electrolytes include electrolyte solutions in addition to the solid electrolytes described above for the cathode layer. The electrolyte solution may be an aqueous electrolyte solution or a non-aqueous electrolyte solution. One kind of electrolyte solution may be used alone, or two or more kinds of electrolyte solutions may be used in combination.

The solvent of the aqueous electrolyte solution contains water as a main component. That is, based on the total amount (100 mol %) of the solvent (liquid component) constituting the electrolyte solution, the proportion of water may be 50 mol % or more, particularly 70 mol % or more, and more particularly 90 mol % or more. There is no particular upper limit to the proportion of water in the solvent.

Although the solvent contains water as a main component, it may also contain a solvent other than water. Examples of solvents other than water include at least one selected from the group consisting of ethers, carbonates, nitriles, alcohols, ketones, amines, amides, sulfur compounds, and hydrocarbons. Based on the total amount (100 mol %) of the solvent (liquid component) constituting the electrolyte solution, the proportion of solvents other than water may be 50 mol % or less, particularly 30 mol % or less, and more particularly 10 mol % or less.

The aqueous electrolyte solution contains an electrolyte. A conventionally known electrolyte may be used as the electrolyte for the aqueous electrolyte solution. Examples of electrolytes include lithium salts of imide compounds, lithium nitrates, lithium acetates, and lithium sulfates. Specific examples of electrolytes include lithium bis(fluorosulfonyl)imide (LiFSI), lithium bis(trifluoromethanesulfonyl)imide (LiTFSI), lithium bis(pentafluoroethanesulfonyl)imide (LiBETI), lithium bis(nonafluorobutanesulfonyl)imide, lithium nonafluoro-N-[(trifluoromethane) sulfonyl]butanesulfonylamide, lithium N,N-hexafluoro-1,3-disulfonylimide, CH₃COOLi, LiPF₆, LiBF₄, Li₂SO₄, and LiNO₃.

The concentration of the electrolyte in the aqueous electrolyte solution can be set as appropriate within a range that does not exceed the saturation concentration of the electrolyte in the solvent, according to the desired battery characteristics. This is because, if a solid electrolyte remains in the aqueous electrolyte solution, the solid may inhibit the battery reaction.

For example, when LiTFSI is used as the electrolyte, the aqueous electrolyte solution may contain 1 mol or more, particularly 5 mol or more, and more particularly 7.5 mol or more, of LiTFSI per 1 kg of the water. There is no particular upper limit to the concentration of the electrolyte. For example, the concentration of the electrolyte may be 25 mol or less.

An electrolyte solution containing a lithium salt and a non-aqueous solvent is usually used as the non-aqueous electrolyte solution.

Examples of lithium salts include inorganic lithium salts such as LiPF₆, LiBF₄, LiCIO₄, and LiAsF₆, and organic lithium salts such as LiCF₃SO₃, LiN(SO₂CF₃)₂ (Li-TFSI), LiN(SO₂C₂F₅)₂, and LiC(SO₂CF₃)₃.
Examples of non-aqueous solvents include ethylene carbonate (EC), propylene carbonate (PC), butylene carbonate (BC), dimethyl carbonate (DMC), diethyl carbonate (DEC), ethyl methyl carbonate (EMC), γ-butyrolactone, sulfolane, acetonitrile (AcN), dimethoxymethane, 1,2-dimethoxyethane (DME), 1,3-dimethoxypropane, diethyl ether, tetraethylene glycol dimethyl ether (TEGDME), tetrahydrofuran, 2-methyl tetrahydrofuran, dimethyl sulfoxide (DMSO), and mixtures thereof. From the standpoint of ensuring high dielectric constant and low viscosity, the non-aqueous solvent may be a mixture of a cyclic carbonate compound having a high dielectric constant and high viscosity such as EC, PC, or BC and a chain carbonate compound having a low dielectric constant and low viscosity such as DMC, DEC, or EMC, or may be a mixture of EC and DEC.
The concentration of the lithium salt in the non-aqueous electrolyte solution may be, for example, from 0.3 M to 5 M.

The non-aqueous electrolyte solution may include an ionic liquid. The ionic liquid may include at least one selected from the group consisting of sulfonium salts, ammonium salts, pyridinium salts, piperidinium salts, pyrrolidinium salts, morpholinium salts, phosphonium salts, imidazolium salts, and derivatives thereof.

The electrolyte layer may include a separator impregnated with the above electrolyte solution and configured to isolate the cathode layer from the anode layer. The material of the separator is not particularly limited as long as it is a porous membrane, and examples include resins such as polyethylene (PE), polypropylene (PP), polyester, polyvinyl alcohol, cellulose, and polyamide. Among these, polyethylene and polypropylene may be used. The separator may have a single-layer structure or a multilayer structure. Examples of separators having a multilayer structure include a separator having a two-layer structure of PE/PP, and a separator having a three-layer structure of PP/PE/PP or PE/PP/PE. The separator may be a nonwoven fabric such as a resin nonwoven fabric or a glass fiber nonwoven fabric.

The battery may further include a restraining jig that applies a restraining pressure along the thickness direction to the cathode layer, the electrolyte layer, and the anode layer. The restraining pressure may be, for example, from 0.1 MPa to 100 MPa. The type of the battery is not particularly limited, and is generally a battery in which metal ions conduct between the cathode layer and the anode layer. Examples of such a battery include a lithium-ion battery. The battery may be either a primary battery or a secondary battery, but may particularly be a secondary battery. This is because it can be repeatedly charged and discharged and is useful, for example, as an in-vehicle battery.

The shape of the battery is not particularly limited. For example, the battery may be a coin battery, a cylindrical battery, a prismatic battery, a sheet battery, a button battery, a flat battery, or a laminated battery.

Examples of applications of the battery include power supplies for vehicles such as hybrid electric vehicles (HEVs), plug-in hybrid electric vehicles (PHEVs), battery electric vehicles (BEVs), gasoline vehicles, and diesel vehicles. In particular, the battery may be used as a drive power supply for hybrid electric vehicles (HEVs), plug-in hybrid electric vehicles (PHEVs), or battery electric vehicles (BEVs). The battery may also be used as a power supply for moving objects other than vehicles (for example, trains, ships, and aircraft), or as a power supply for electrical products such as information processing devices.

### Examples 1 to 4 and Comparative Example 1

### Synthesis of Precursor of Cathode Active Material

NiSO₄, CoSO₄, and MnSO₄ were dissolved in deionized water to prepare an aqueous metal source solution. The Ni/Co/Mn ratio in the aqueous metal source solution was set to 80/10/10 in mol %. The concentration of the aqueous metal source solution (the proportion of all the metal sources in the aqueous metal source solution) was set to 1.5 mol %. A certain amount of NH₃ aqueous solution was placed in a reaction vessel, and while stirring with a stirrer, the inside of the reaction vessel was purged with nitrogen gas. An aqueous NaOH solution was then added to the reaction vessel, and while maintaining the pH at an alkaline level as shown in Table 1, the aqueous metal source solution and the aqueous NH₃ solution were added dropwise into the reaction vessel over 15 hours at the temperature and nitrogen gas flow rate shown in Table 1.

After completion of the reaction, a drying treatment was carried out at 110° C. for 10 hours under an inert gas atmosphere.

TABLE 1

| | | Temperature | Nitrogen Gas Flow Rate |
|---|---|---|---|
| | pH | (° C.) | (L/min) |
| Example 1 | 12.0 | 50 | 5.0 |
| Example 2 | 11.5 | 60 | 5.0 |
| Example 3 | 11.3 | 50 | 2.0 |
| Example 4 | 11.3 | 65 | 6.0 |
| Comparative Example 1 | 11.0 | 45 | 0.5 |

For the obtained precursors of Examples 1 to 4 and Comparative Example 1, pore distribution measurement was performed by mercury intrusion porosimetry using a mercury porosimeter, and the average pore size and the total pore specific surface area were calculated. The average pore sizes and total pore specific surface areas of the precursors are shown in Table 2.

### Synthesis of Cathode Active Material

Each of the precursors of Examples 1 to 4 and Comparative Example 1 synthesized as described above and a lithium compound (LiOH) serving as a lithium source were mixed in a mortar. Each of the resulting mixtures was calcined in a calcination furnace at 750° C. for 10 hours under an oxygen atmosphere to synthesize cathode active materials (LiNi_{0.8}Co_{0.1}Mn_{0.1}O₂) of Examples 1 to 4 and Comparative Example 1.

### Cell Fabrication

Small laminate cells of Examples 1 to 4 and Comparative Example 1 were fabricated using the cathode active materials of Examples 1 to 4 and Comparative Example 1, respectively.

Specifically, a cathode composite paste containing the cathode active material and acetylene black as an electrically conductive material was applied to the surface of a metal foil serving as a cathode current collector using a film applicator with a thickness adjustment function (manufactured by Allgood Co., Ltd.). The coating was then dried at 80° C. for five minutes in a dryer to prepare a cathode having a cathode layer on the cathode current collector. Meanwhile, an anode composite paste containing natural graphite as an anode active material was applied to the surface of a metal foil serving as an anode current collector using a film applicator with a thickness adjustment function (manufactured by Allgood Co., Ltd.). The coating was then dried at 80° C. for five minutes in a dryer to prepare an anode having an anode layer on the anode current collector.
A 1 M LiPF₆ solution containing LiPF₆ as an electrolyte and ethylene carbonate (EC), dimethyl carbonate (DMC), and ethyl methyl carbonate (EMC) as a solvent in a volume ratio of EC/DMC/EMC=3/4/3 vol % was prepared as an electrolyte solution.
The cathode, a separator, and the anode were stacked, and the separator was impregnated with the electrolyte solution. The small laminate cells of Examples 1 to 4 and Comparative Example 1 were thus fabricated.

### Cell Evaluation

For each of the fabricated small laminate cells, the discharge capacity was measured before and after a cycle test. The cycle test was conducted for 200 cycles under the following conditions.

### Discharge Capacity Measurement Conditions

C-rate: 0.1C
Measurement mode: CC-CV discharge
Temperature: 25° C.

### Cycle Test Conditions

C-rate: 0.3C
Mode: CC charge/discharge
Temperature: 25° C.

From the discharge capacity values measured before and after the cycle test, the capacity retention after the cycle test was calculated using the following equation. The results are shown in Table 2.

Capacity retention (%)=(Capacity after cycle test)/(Capacity before cycle test)×100

TABLE 2

| | | Total Pore | |
|---|---|---|---|
| | Average | Specific | Capacity Retention |
| | Pore Size | Surface Area | After Cycle Test |
| | (μm) | (m²/g) | (%) |
| Example 1 | 5.80 | 0.11 | 89 |
| Example 2 | 6.30 | 0.09 | 90 |
| Example 3 | 4.20 | 0.25 | 88 |
| Example 4 | 8.90 | 0.06 | 89 |
| Comparative Example 1 | 3.60 | 0.26 | 78 |

As shown in Tables 1 and 2, comparison between Comparative Example 1 and Example 3 shows that, in the synthesis of the precursor of the cathode active material, increasing the nitrogen gas flow rate from 0.5 L/min to 2.0 L/min, the reaction temperature from 45° C. to 50° C., and the pH from 11.0 to 11.3 results in an increase in the average pore size and a decrease in the total pore specific surface area of the precursor.

As shown in Tables 1 and 2, comparison between Example 3 and Example 1 shows that, in the synthesis of the precursor of the cathode active material, when the reaction temperature is 50° C., changing the nitrogen gas flow rate from 2.0 L/min to 5.0 L/min and the pH from 11.3 to 12.0 results in an increase in the average pore size and a decrease in the total pore specific surface area of the precursor.
As shown in Tables 1 and 2, comparison between Example 1 and Example 2 shows that, in the synthesis of the precursor of the cathode active material, when the nitrogen gas flow rate is 5.0 L/min, changing the reaction temperature from 50° C. to 60° C. results in an increase in the average pore size and a decrease in the total pore specific surface area of the precursor, even if the pH is changed from 12.0 to 11.5.
As shown in Tables 1 and 2, comparison between Example 2 and Example 4 shows that, in the synthesis of the precursor of the cathode active material, changing the nitrogen gas flow rate from 5.0 L/min to 6.0 L/min and the reaction temperature from 60° C. to 65° C. results in an increase in the average pore size and a decrease in the total pore specific surface area of the precursor, even if the pH is changed from 11.5 to 11.3.
From the above, it is apparent that, in the synthesis of the precursor of the cathode active material, when the pH is within the range of 11.0 to 12.0, either increasing the nitrogen gas flow rate or increasing the reaction temperature, or both, results in an increase in the average pore size and a decrease in the total pore specific surface area of the precursor.
As shown in Table 2, pore distribution measurements by mercury intrusion porosimetry confirmed that Examples 1 to 4, which had an average pore size of more than 3.60 μm and a total pore specific surface area of less than 0.26 m²/g, exhibited higher capacity retention after the cycle test and superior cycle performance compared with Comparative Example 1, in which both the average pore size and the total pore specific surface area were outside the above ranges.

What is claimed is:

1. A precursor of a cathode active material, the precursor comprising
secondary particles each including a plurality of primary particles aggregated together, wherein:
the primary particles include a nickel composite hydroxide; and
the precursor has an average pore size of more than 3.60 μm and a total pore specific surface area of less than 0.26 m²/g, as measured by mercury intrusion porosimetry.

2. The precursor according to claim 1, wherein the average pore size is 8.90 μm or less, and the total pore specific surface area is 0.06 m²/g or more.

3. The precursor according to claim 1, wherein the average pore size is 4.20 μm or more, and the total pore specific surface area is 0.25 m²/g or less.

4. The precursor according to claim 1, wherein the nickel composite hydroxide is a nickel-cobalt-manganese composite hydroxide.
